(19) United States
(12) Patent Application Publication
(10) Pub. No.: US 2025/0131362 A1
(43) Pub. Date: Apr. 24, 2025

(54) AUTOMATED DATA STRUCTURES FOR GOAL MANAGEMENT

(71) Applicant: Microsoft Technology Licensing, LLC, Redmond, WA (US)

(72) Inventors: Oz SOLOMON, Maple (CA); Monroe Milas THOMAS, Toronto (CA); Joseph Jacques-André CHAMBERLAND, Toronto (CA); Fernando N. VITON, Kirkland, WA (US); Matthew James STEPHURE, Toronto (CA); Fatemeh JAFARGHOLI, Toronto (CA)

(73) Assignee: Microsoft Technology Licensing, LLC, Redmond, WA (US)

(21) Appl. No.: 18/493,762

(22) Filed: Oct. 24, 2023

(51) Int. Cl. G06Q 10/0637

(52) U.S. Cl. CPC G06Q 10/0637

(57) ABSTRACT

Users create, view, and interact with massive amounts of content every day, including browsing websites, engaging with social platforms, collaborating electronically with friends and colleagues, transacting with apps and/or plugins, creating and editing documents, and the like. Traditionally, the content associated with various user interactions is siloed based on the entity with which the user interacts. Accordingly, to achieve a goal, it is up to the user to compile content across various sources, identify and organize tasks and subtasks, and track progress and completion of the goal. The present application determines a goal for a user based on monitoring user interactions. A data structure is created for the goal, including determining applicable tasks and subtasks. The data structure becomes a living entity for storing and tracking the goal by continuing to monitor user interactions and determine the user's progress towards completion of each task and, ultimately, the goal.

### BACKGROUND

People use computer systems on a daily basis to help organize and complete many different tasks. Often the separate tasks are related to a goal. For example, a goal of planning a trip involves many different tasks and/or subtasks, such as booking hotel room, tours, rental cars, etc. Indeed, users create, view, and interact with significant amounts of content every day in furtherance of such goals including browsing websites (e.g., researching, making online purchases, querying, etc.), engaging with social platforms (e.g., Facebook®, LinkedIn®, Twitter® (“X”), Snapchat®, Instagram®, etc.), collaborating electronically with friends and colleagues (e.g., via Microsoft® Teams®, Slack®, Google® Meet™, Zoom®, etc.), collaborating non-electronically with friends and colleagues (e.g., via an in-person conversation monitored by a microphone of a device and transcribed), transacting with apps and/or plugins (e.g., booking hotels, renting cars, reserving restaurants, requesting directions, viewing weather, scheduling events, SMS texting, etc.), creating and editing documents (e.g., spreadsheets, presentations, word processing documents, task lists, calendars, etc.), querying electronic assistants (e.g., Microsoft® Cortana®, Amazon® Alexa®, Google® Assistant™, etc.), accessing files (e.g., image files, audio files, video files, textual files, etc.), and the like. One issue with such interactions and task completion relates to the fact that the user must compile content across various these sources, identify and organize tasks and subtasks, and track progress and completion of the goal, including managing conflicts between subtasks and the like.

It is with respect to these and other general considerations that embodiments have been described. Also, although relatively specific problems have been discussed, it should be understood that the embodiments should not be limited to solving the specific problems identified in the background.

### SUMMARY

Aspects of the present application relate to monitoring activity such as user interactions or related electronic system to automatically identify, organize, and track goals and objectives for a user. In aspects, the system may non-intrusively and continuously monitor and capture content associated with user interactions, which may be processed to determine a “goal” that the user seeks to achieve, e.g., plan a birthday party, purchase a snowboard, plan a family vacation, etc. In some aspects, the system may receive user input regarding a goal the user intends to accomplish. The system may further automatically determine one or more tasks and/or subtask for achieving the goal and builds a data structure (referred to herein as a “plan”) for the goal based on the determined tasks and/or subtasks. In aspects, the term “task” is used herein to refer to something that needs to be achieved to satisfy a goal, and the term “subtask” is used herein to refer to something that needs to be achieved to satisfy a task. However, the terms “task” and “subtask” are not so limiting because either a task or subtask can be thought of as its own “goal” to be achieved. As the system continues to monitor and record user interactions, determinations are made regarding the focus of the user's intention or the “goal-in-focus.” By determining the user's focus, the system is able to determine which goal, task, subtask, etc., to update. Moreover, based on updating a goal, for example, the system may revise tasks, subtasks, etc., beyond the goal-in-focus. This enables the system to be scalable and performant. When the system cannot determine a goal-in-focus with sufficient confidence, this is a signal that a new goal may need to be created and populated with an initial set of tasks, subtasks, etc., or a new task may need to be created for an existing goal, among other examples. The plan (e.g., data structure) corresponding to the goal is updated, revised, or created accordingly so as to track completion of a goal. In aspects, all or portions of the plan (e.g., data structure) can be surfaced (or materialized) in an application, an interface, or the like, for presentation to or sharing by a user.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system according to aspects of the present disclosure.

FIGS. 2A-2C illustrate an overview of example plan data structures according to aspects described herein.

FIGS. 3A-3B illustrate an overview of an example method of generating a plan to track a goal according to aspects described herein.

FIG. 4 illustrates an overview of an example interface for surfacing a plan according to aspects described herein.

FIG. 5 illustrates an overview of an example interface for interacting with a frontend of a plan according to aspects described herein.

FIG. 6 is a block diagram illustrating example physical components of a computing device with which aspects of the disclosure may be practiced.

FIG. 7 is a simplified block diagram of a computing device with which aspects of the present disclosure may be practiced.

FIG. 8 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As detailed above, users create, view, and interact with massive amounts of content every day, including browsing websites (e.g., researching, making online purchases, querying, etc.), engaging with social platforms (e.g., Facebook®, LinkedIn®, Twitter® (“X”), Snapchat®, Instagram®, etc.), collaborating electronically with friends and colleagues (e.g., via Microsoft® Teams®, Slack®, Google® Meet™, Zoom®, etc.), collaborating non-electronically with friends and colleagues (e.g., via an in-person conversation monitored by a microphone of a device and transcribed), transacting with apps and/or plugins (e.g., booking hotels, renting cars, reserving restaurants, requesting directions, viewing weather, scheduling events, SMS texting, etc.), creating and editing documents (e.g., spreadsheets, presentations, word processing documents, task lists, calendars, etc.), querying electronic assistants (e.g., Microsoft® Cortana®, Amazon® Alexa®, Google® Assistant™, etc.), accessing files (e.g., image files, audio files, video files, textual files, etc.), and the like. Traditionally, the content associated with the vast number of user interactions is siloed based on the entity with which the user interacts (e.g., website, application, plugin, social platform, etc.). Accordingly, to achieve a goal or objective, it is up to the user to compile content across various sources (including human-to-human conversations), identify and organize tasks and subtasks, and track progress and completion of the objective.

Aspects of the present application relate to monitoring user interactions to automatically identify, organize, and track goals and objectives for a user. A user interaction may include an active interaction with a computing device (e.g., user directly utilizes a computing device to type, listen, speak, view, etc., for interacting with content or other people) or a passive interaction with a computing device (e.g., computing device passively monitors the user via a microphone to capture an in-person conversation or a camera to capture the user writing on a piece of paper). In aspects, the system may non-intrusively and continuously monitor and capture content associated with user interactions, which may be processed to determine a goal that the user seeks to achieve, e.g., plan a birthday party, purchase a snowboard, plan a family vacation, etc. In some aspects, the system may receive user input regarding a goal the user intends to accomplish. The system may further automatically determine one or more tasks and/or subtasks for achieving the goal and builds a data structure (hereinafter referred to as a “plan”) based on the determined tasks and/or subtasks.

As the system continues to monitor and record user interactions, determinations are made regarding whether to update an existing goal, revise an existing goal, create a new goal, and/or update, revise, or create one or more tasks and/or subtasks. The plan (e.g., data structure) corresponding to the goal is updated, revised, or created accordingly so as to track completion of the goal. In aspects, all or portions of the plan (e.g., data structure) can be surfaced (or materialized) in an application, an interface, or the like, for presentation to or sharing by a user.

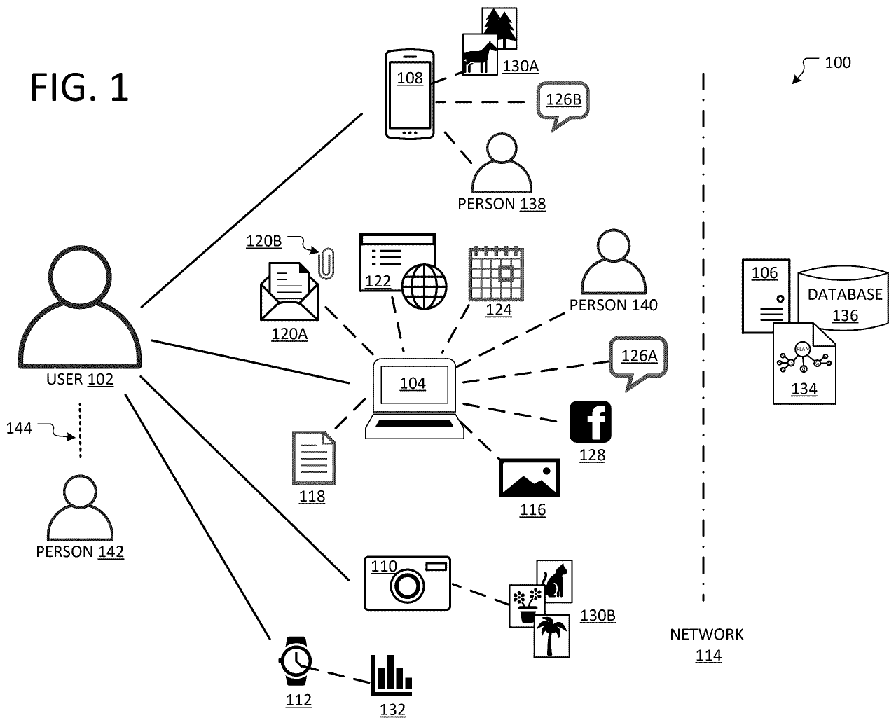

FIG. 1 illustrates an overview of an example system 100 according to aspects of the present disclosure. As illustrated, system 100 includes user 102, computing device 104, server 106, mobile device 108, camera 110 (e.g., Internet-of-Things (IoT) device), watch 112 (e.g., IoT device), and network 114. In examples, user 102 interacts with computing device 104, mobile device 108, camera 110, and watch 112, which can communicate with one another and/or server 106 via network 114. User 102 may further communicate with person 138 via mobile device 108 and person 140 via computing device 104. Additionally, user 102 may conduct an in-person communication 144 with person 142, which may be captured by a microphone associated with any of computing device 104, mobile device 108, camera 110, and/or watch 112. Such a communication 144 may then be transcribed by any of the aforementioned devices or another device, for example. Network 114 may comprise a local area network, a wireless network, or the Internet, or any combination thereof, among other examples. While aspects of the present invention relate to monitoring user interactions, those skilled in the art will appreciate that the system 100 may further monitor other electronic devices (not shown) for related information without always requiring user interaction.

As detailed above, users create, edit, view, and otherwise interact with massive amounts of content associated with a vast array of entities or sources, including interactions with applications, files, plugins, websites, databases, artificial intelligence (AI) agents, search engines, browsers, software services, social platforms, conferencing platforms, collaboration platforms, and the like. The user 102 may have a number of implicit goals when performing these various interactions, for example, purchasing a new car, planning a party or vacation, losing weight, getting fit, and the like. By monitoring user interactions with various devices (e.g., computing device 104, mobile device 108, camera 110, watch 112, and the like) and recording and evaluating content associated therewith, these implicit goals may be determined. In other examples, the user 102 may explicitly specify a goal. In other aspects, content recorded based on interactions with different devices may include different content types and formats (e.g., audio, video, image, streaming, graphic, text, HTTP, XML, and the like). Accordingly, to determine a goal, the recorded content may be processed into a format suitable for evaluation. In some aspects, content may be clustered or grouped to determine a goal associated with the clustered content.

Turning to computing device 104, user 102 may interact with various entities (e.g., applications, websites, social platforms, collaboration platforms, and the like) to create, edit, view, and otherwise interact with vast amounts of content. For example, user 102 may utilize a photoshop application to interact with image(s) 116 and a productivity application (e.g., word processing application, spreadsheet application, presentation applications, collaboration application, etc.) to interact with document(s) 118. In some examples, if document(s) 118 are collaborative, user 102 may further communicate with person 140 via document(s) 118. User 102 may utilize an email application to interact with email 120A and/or attachment 120B (e.g., a document, image, audio recording, link, etc.) to communicate with person 140, for instance. A calendar application may be used to interact with calendar 124 and a browser may be utilized to interact with various websites associated with internet content 122, which may include multiple content types, e.g., text, image, audio, video, etc. Communication content 126A may be created when user 102 communicates via chat, audio, or video with one or more other people (e.g., person 140) or an AI agent, for example, using a collaboration, AI, or conferencing application. User 102 may utilize a social media platform, for example, to interact with social content 128 and/or person 140, for example.

User 102 may further interact with mobile device 108, which may enable access to the same or similar content as computing device 104, including image(s) 116, document(s) 118, email(s) 120A and attachment(s) 120B, internet content 122, calendar 124, communication content 126A, and/or social content 128. Additionally, user 102 may interact with mobile device 108 to create communication content 126B, which may include SMS text communications and/or audio recordings of voice communications with person 138, for example. Mobile device 108 may also be utilized to capture, store, edit, share, and view pictures 130A, for instance. Similarly, user 102 may use camera 110 to capture, store, edit, share, and view pictures 130B. Watch 112 may capture data 132 associated with the user 102, including vital signs, daily steps, calories burned, user location, and the like. As should be appreciated, any number of other IoT devices, such as video cameras, appliances, personal assistants, etc., may further interact (in some cases, passively) to gather content associated with user 102. As should be appreciated, the above examples of entities with which a user 102 may interact, as well as the content created or associated with these interactions, are provided for explanatory purposes only and should not be considered limiting in any way.

In some aspects, server 106 may evaluate content captured or recorded by devices with which user 102 has interacted, including but not limited to computing device 104, mobile device 108, camera 110, and/or watch 112. In other aspects, computing device 104 and/or mobile device 108 may have sufficient processing capacity and/or memory to evaluate content recorded based on user interactions. Content may be evaluated to determine whether the content is related to an existing goal, related to a new goal intended by the user, or unrelated to a goal. Based on the content, when the system is unable to determine with a degree of confidence that the focus of the user's intent is an existing goal, this may signal to the system that the user intends a new goal or no goal at all. In aspects, a determination that content is unrelated to a goal may be based on various factors, e.g., the amount of content is insufficient to detect a user intention (e.g., short text thread without context), the content relates to an isolated event or topic (e.g., meeting place for lunch today, query for random fact, etc.), the content has no correspondence or similarity to other content (e.g., a query for a location not previously searched or visited), user interaction is unrelated to a goal (e.g., watching a cat video, scrolling a social media or news feed, etc.), to name a few. However, as user interactions continue to be monitored and evaluated, content that was previously determined to be unrelated may later be deemed related to a goal, e.g., additional queries are conducted regarding a location, including nearby schools, nearby restaurants, and apartments for rent. In this case, an initial query regarding a location may be determined to be related to a new “goal to move.”

As noted above, in some cases, it may be determined that a new goal is intended by a user based on an evaluation of recorded content from user interactions. For example, content may be recorded for user interactions including browsing surfboards on a sporting goods website, placing a bid for a surfboard on an online auction site, and querying a search engine for surfboarding courses. Evaluation of the recorded content may identify similarities and these user interactions may be clustered or grouped. In other aspects, the recorded content may be evaluated independently. Based on the evaluation, it may be determined that the goal associated with these interactions is to “learn to surf.” In another example, content may be recorded for user interactions with a spreadsheet entitled “Birthday Party Budget,” a website associated with a bakery, and a search engine for querying party supply stores. Based on evaluating the recorded content, it may be determined that the goal associated with these interactions is to “plan a birthday party.” In some cases, user 102 may explicitly indicate a new goal or explicitly confirm a new goal determined by the system.

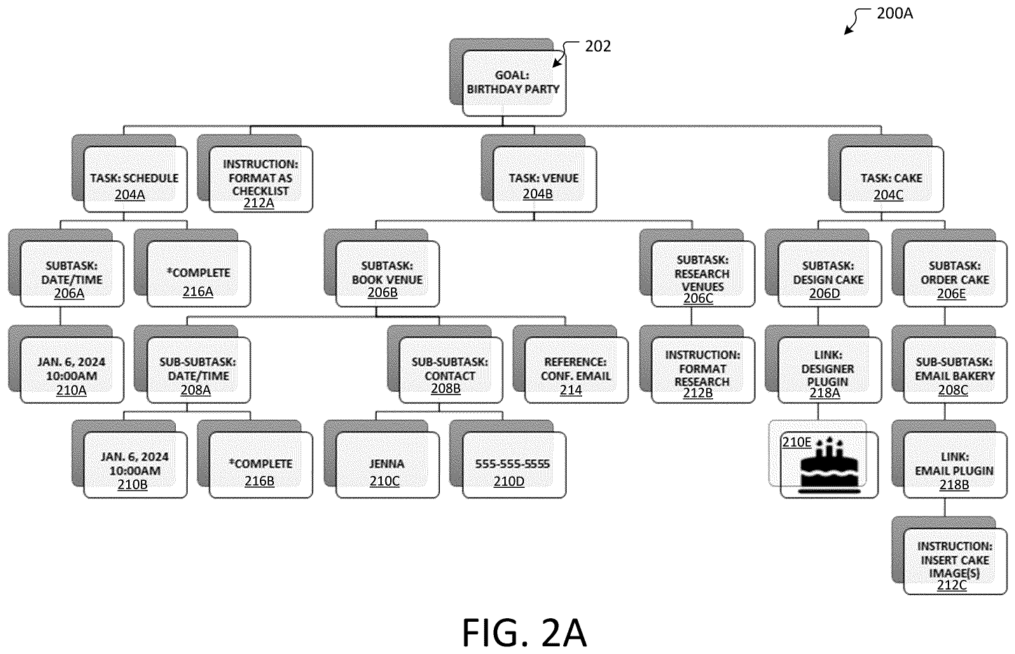

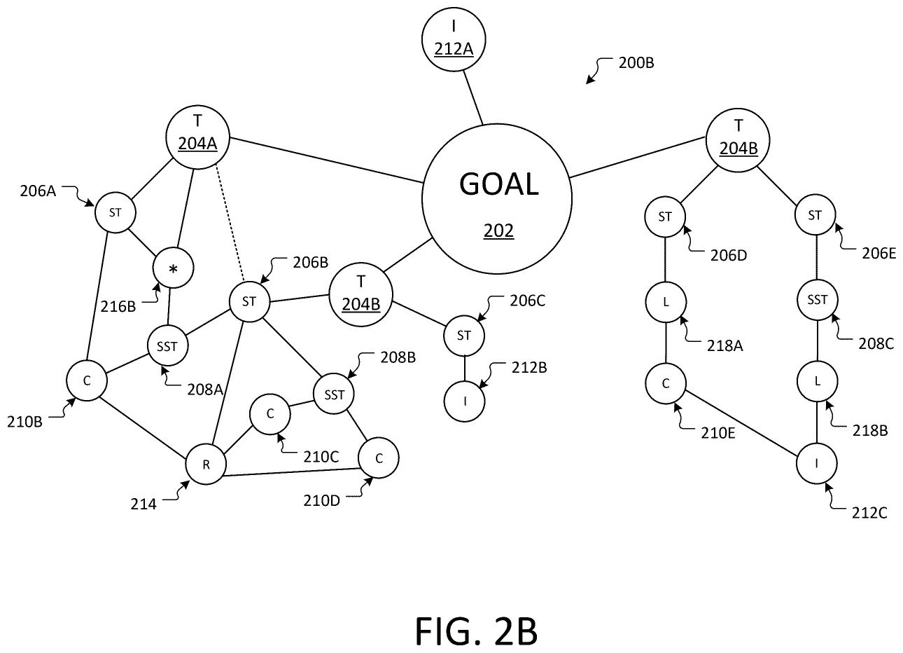

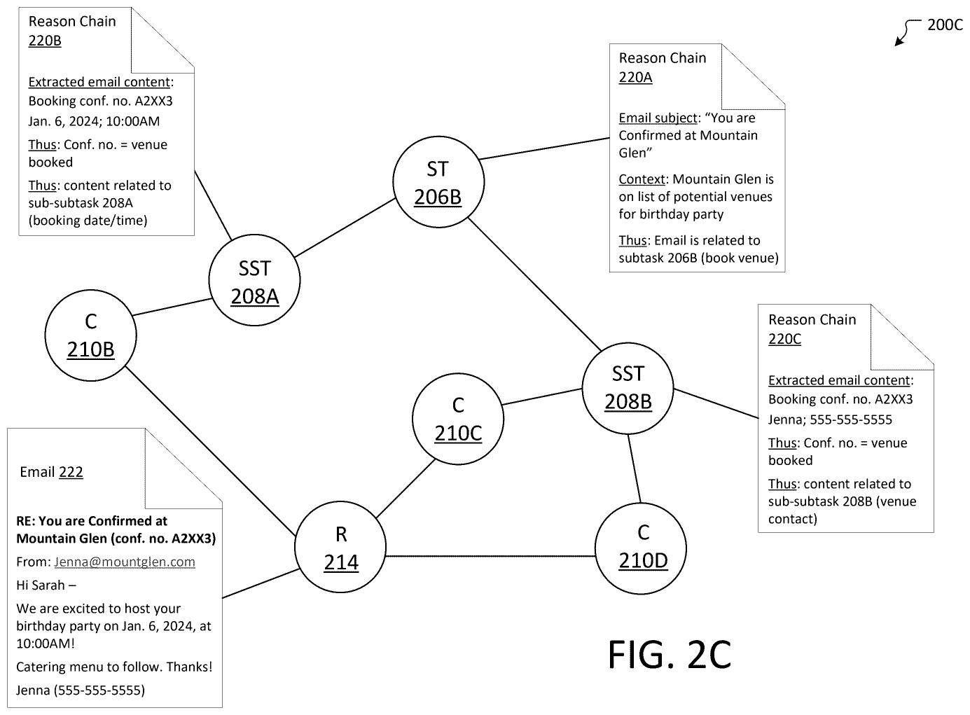

Once a new goal is determined, a plan 134 may be created to store the goal and any associated information. As further described with reference to FIGS. 2A-2B, the plan 134 may be created in any suitable form by any suitable means. For instance, the plan 134 may be in the form of a hierarchical structure (e.g., file/folder structure), a node structure (e.g., graph database), a relational structure (e.g., SQL database), and the like. In aspects, the plan 134 is generated in a form that may be processed by a machine-learning model (e.g., large language model) and/or surfaced by an application or interface for presentation to the user. The plan 134 and/or information related to a goal may be stored in database 136, for example.

Additionally, once a new goal is determined, one or more tasks, subtasks, sub-subtasks, etc., may be determined for the new goal. As should be appreciated, different tasks, subtasks, etc., may be determined for different goals. For example, with reference to the examples above, tasks for a goal to “learn to surf” may include:

(1) research surf schools, which may include subtasks of (a) reading customer reviews, (b) reviewing instructor bios, and (c) identifying a course schedule;

(2) research best surfing beaches for beginners, including subtasks of identifying (a) locations, (b) lifeguard services, (c) fees, (d) parking, and (e) hours of operation;

(3) purchase a surfboard, including subtasks of researching (a) suitable surfboards for beginners, (b) pros and cons of used versus new surfboards, and (c) physical and/or online stores for purchasing new or used surfboards; and

(4) book a surfing course, including subtasks of (a) adding the course to the calendar, (b) storing address and contact information, and (c) storing a booking number or other reservation information.

The determined tasks, subtasks, etc., may be used to build the plan 134 created for the goal. For example, depending on the type of plan 134, a parent node or top-level folder may represent the goal and each task may be associated with the top-level folder or parent node as a subfolder or child node. Each subtask may be associated with one or more tasks as a sub-subfolder or sub-child node, and so forth. In some aspects, tasks or subtasks may influence or relate to other tasks or subtasks within plan 134. For example, confirmation of a venue or cake delivery may influence the date and/or time a party may be scheduled. In this case, child nodes representing these different tasks (e.g., booking a venue, ordering a cake, scheduling the party) in plan 134 may point to one another in addition to pointing to the parent node associated with the goal of planning a party. In further examples, multiple plans 134 may be created and related to one another. For example, plan 134 may be created for each task and may be linked together based on the same goal. As progress of the goal is tracked, information (or data) may be captured or generated for each task, subtask, sub-subtask, etc. In aspects, the information itself, pointers or references to the information, or instructions for retrieving the information may be stored in the plan 134, for example.

In aspects, rather than merely generating a list of tasks/subtasks for the user, the system may automatically identify or retrieve related information, whether previously stored or currently retrieved from another location. With reference to the example above, the system may automatically identify or retrieve information regarding nearby surfing schools, along with links to websites, reviews, bios of instructors, and course schedules. The system may further retrieve information regarding beaches suitable for novice surfers, along with information regarding locations, lifeguard services, fees, parking, hours of operation, etc. Information may also be retrieved regarding suitable novice surfboards, pros and cons of buying vs. renting, pros and cons of purchasing used vs. new surfboards, and links to physical and/or online store websites for renting or purchasing new or used surfboards. With the advent of large language models (LLMs), or other AI technology now known or developed in the future, information may be retrieved very quickly, e.g., in near real-time. Accordingly, instructions to an LLM (or other resource) for retrieving information related to the goal may also be stored in the plan 134.

In further aspects, the system may determine a suitable format for presenting information to the user regarding a goal, tasks, subtasks, etc. For instance, with reference to the example above, a presentation format for the goal of “learning to surf” may be organized by task, whereas a presentation format for the goal of “planning a family vacation to Asia” may be organized as an itinerary by proposed date. Furthermore, suitable presentation formats for different types of information may be determined. For instance, information regarding each surf school may be presented in a chart format so that the user can easily compare the schools. In contrast, information regarding different beaches may be presented in a map format, with popups showing additional information regarding each site. In some aspects, the system may determine a suitable presentation format based on the type of goal, the type of tasks/subtasks, the type of information, etc. In other aspects, the user 102 may specify a presentation format. In aspects, rather than storing the formatted information in the plan 134, instructions for presenting the information may be stored.

Once a goal is established and a plan 134 is created, the goal may be referred to as an “existing goal.” As noted above, user interactions may continue to be monitored and content recorded based on the monitoring may be evaluated to determine whether the content is related to an existing goal. That is, the system may attempt to determine which goal (or task, subtask, etc.) is the focus of the user's intent based on the recorded content. For example, the content may be evaluated for correspondence or similarity to existing tasks, subtasks, etc., for existing goals associated with the user 102. When it is determined with a degree of certainty that the recorded content is related to an existing goal, it may be determined whether the content supports or conflicts with the existing goal. For example, for the existing goal of “planning a family vacation to Asia,” content related to booking a hotel for all or a portion of the trip dates may be determined to support the existing goal; whereas content related to a text thread indicating the user instead intends to take “a family vacation to Europe” may be determined to conflict with the existing goal. In another example, content may be determined to support an existing goal but conflict with a task or subtask. For instance, content may indicate that the user wishes to change a hotel or visit an additional or different city in Asia. While supporting the goal of “planning a family vacation to Asia,” this content may conflict with the current itinerary (e.g., task or subtask on a particular day). In this case, the task or subtask may be revised in response to the content.

When content is determined to support an existing goal, the plan 134 corresponding to the existing goal may be updated with the content. In some examples, the content itself may be stored in the plan 134 (e.g., a confirmation number for booking a flight); whereas in other examples, instructions for retrieving the content or a reference to the content in storage (e.g., database 136) may be added to the plan 134. In some cases, it may be determined that the content (e.g., booking confirmation) completes a task or subtask (e.g., task to book a flight). A file or node corresponding to the task or subtask in the plan 134 may then be flagged as completed. When content is determined to conflict with an existing goal, the content may be further evaluated and, in some cases, an interaction with the user may be initiated. For example, an AI agent may request clarification regarding whether the user has changed the goal for the family vacation from Asia to Europe or whether the user intends to plan an additional family vacation to Europe (perhaps, next year). In the extreme case in which it appears the user has decided to abandon a goal entirely (e.g., cancel the trip), user confirmation may be requested.

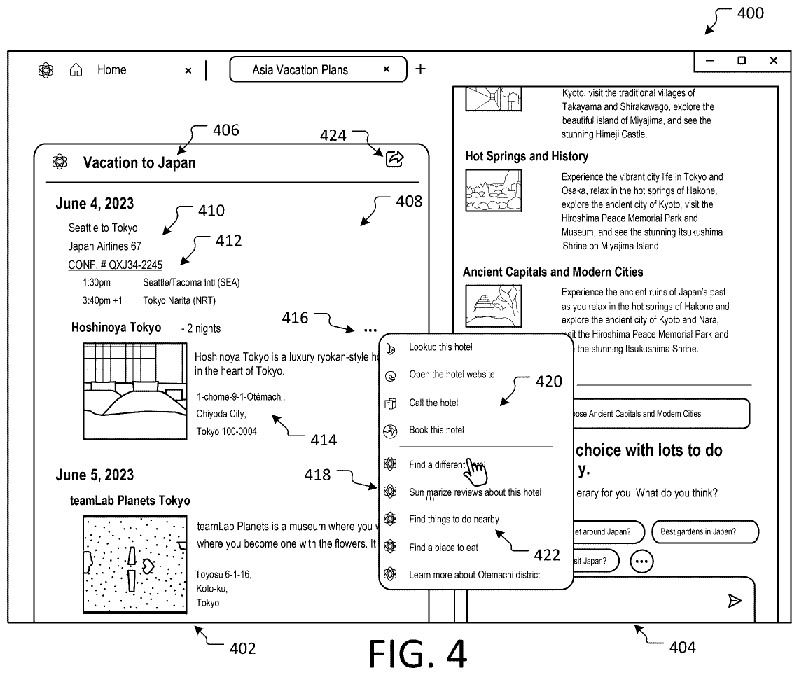

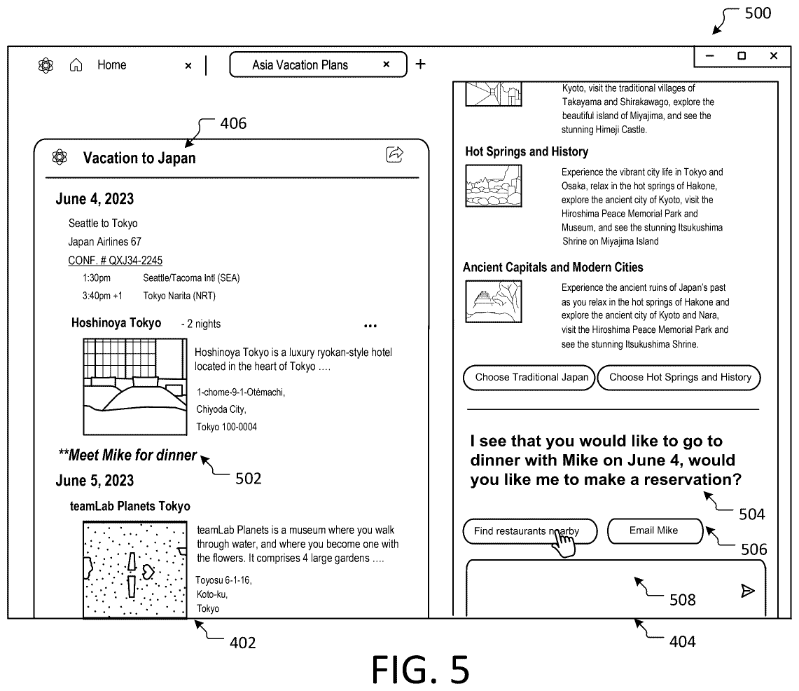

In some cases, as will be discussed further with respect to FIGS. 4 and 5, the plan 134 may be surfaced or materialized in a user-facing form. For instance, the user may request that the plan 134 be surfaced in an application or interface as any type of document (e.g., word document, spreadsheet, presentation, email, etc.). The plan 134 may also be shared with other users, applications, LLMs, etc., via any suitable means (e.g., as an attachment or link to email, within a collaborative platform, via text, or otherwise). In further examples, when the plan 134 has been materialized, it may include a frontend “user-facing” aspect and a backend “model-facing” aspect. The frontend may be formatted and organized for presentation to the user, as described above. In contrast, the backend may include context, prompts, commands, etc., associated with retrieving information, formatting, etc. For example, the backend may instruct an LLM to “research and choose a suitable Asian country for a family vacation,” “find comfortable and child-friendly accommodations in the chosen destination,” or “arrange for transportation to and from the chosen destination.” The backend may further include links or back references to content that led to various determinations (e.g., a link to a chat message in which the user 102 expressed an intention to change the family vacation from Asia to Europe) and/or to the reasoning chains that led to various determinations manifested on the frontend (e.g., user 102 expressed an intention to vacation in Asia over particular dates, then the user 102 booked a flight to Asia over the particular dates, therefore the task to book the flight is complete). The backend may not be visible to the user; however, if the plan 134 is shared with other users or applications, the backend may also be shared in order to provide context to a recipient application and/or model.

In aspects, processing or evaluations of content associated with one or more user interactions may be conducted based on various machine learning (ML) models, algorithms, large language models (LLMs), or other analyses, either now known or developed in the future. For example, a generative model (also generally referred to herein as a type of machine learning (ML) model) may be used according to aspects described herein and may generate any of a variety of output types (and may thus be a multimodal generative model, in some examples). For example, the generative model may include a generative transformer model and/or a large language model (LLM), a generative image model, or the like. Example ML models include, but are not limited to, Megatron-Turing Natural Language Generation model (MT-NLG), Generative Pre-trained Transformer 3 (GPT-3), Generative Pre-trained Transformer 4 (GPT-4), BigScience BLOOM (Large Open-science Open-access Multilingual Language Model), DALL-E, DALL-E 2, Stable Diffusion, or Jukebox.

FIG. 2A illustrates an overview of an example plan 200A according to aspects described herein. Plan 200A is an example hierarchical data structure representing a goal 202 of “planning a birthday party.” Plan 200A has multiple levels, including task(s) 204A-C, subtasks 206A-E, and sub-subtasks 208A-C. Further, content 210A-E, instructions 212A-B, reference 214, completion indicators 216A-B, and links 218A-B modify or relate to one or more of the goal 202, tasks 204A-C, subtasks 206A-E, and/or sub-subtasks 208A-C.

As illustrated, goal 202 for the birthday party is represented in a first level of plan 200A. In a second level, instruction 212A refers to formatting goal 202 as a checklist for presentation to the user. In this case, when plan 200A is surfaced, an application or interface may ingest instruction 212A and present goal 202 in a checklist format. Additionally, in the second level of the hierarchical structure, goal 202 includes tasks 204A-C, more specifically, schedule task 204A, venue task 204B, and cake task 204C.

A third level of plan 200A includes items relating to tasks 204A-C. For instance, subtask 206A (schedule date/time) and completion indicator 216A refer to schedule task 204A; subtask 206B (book venue) and subtask 206C (research venues) relate to venue task 204B; and subtask 206D (design cake) and subtask 206E (order cake) refer to cake task 204C.

Similarly, a fourth level of plan 200A includes items relating to subtasks 206A-E. As illustrated, content 210A relates to subtask 206A (schedule date/time). In aspects, content 210A may store the content (e.g., data), pointer(s) to content stored elsewhere (e.g., database 136), or instructions for retrieving content (e.g., readable by an LLM). As illustrated, content 210A is a date and time, i.e., Jan. 6, 2024, at 10:00 AM. In aspects, content 210A may be obtained based on monitoring user interactions, such as recording a text thread in which the user invites a neighbor to the birthday party on Jan. 6, 2024, at 10:00 AM, or based on explicit user input. Upon evaluating the text thread, it may be determined that the text thread relates to the subtask 206A (schedule date/time) of schedule task 204A for the birthday party goal 202. The date and time may be extracted from the text thread and added as content 210A to subtask 206A (schedule date/time). In aspects, it may be determined that the content 210A completes subtask 206A (schedule date/time) and, consequently, completes schedule task 204A, which may be flagged in the plan 200A with completion indicator 216A.

In other examples, task 204A (schedule party) may be dependent upon subtask 206B (book venue) (illustrated by a dotted line). That is, the venue may need to be booked before the birthday party can be scheduled. In this case, content 210B may be obtained by monitoring user interactions, such as recording a confirmation email from a venue. The confirmation email may include, among other things, the date and time of booking (e.g., Jan. 6, 2024, at 10:00 AM), a contact name/phone number (e.g., Jenna, 555-555-5555), an address of the venue, and the like. In response to determining that the confirmation email is related to booking the venue for the birthday party, the system may extract and store the booking date and time as content 210B associated with sub-subtask 208A (booking date/time). The system may further determine that the content 210B completes sub-subtask 208A (booking date/time), which may be flagged with completion indicator 216B. In this example, upon determining that content 210B completes sub-subtask 208A (booking date/time), the system may further determine that content 210B completes subtask 206A (schedule date/time) and, consequently, schedule task 204A. In this case, better illustrated by FIG. 2B, content 210B may point to both sub-subtask 208A (booking date/time) and subtask 206A (schedule date/time). Further, better illustrated by FIG. 2B, in response to determining that sub-subtask 208A (booking date/time) is completed, thereby completing subtask 206A (schedule date/time) and schedule task 204, completion indicator 216B may point to each of sub-subtask 208A, subtask 206A, and schedule task 204A (not shown). In embodiments, the system itself is the entity that is making the completion determination based on a reasoning chain that a goal is complete and thus applies the completion flag. In other embodiments, direct user interaction may be used to determine completion.

Further using the example above, in response to determining that the confirmation email is related to booking the venue, the contact name and phone number (e.g., Jenna, 555-555-5555) may be extracted and stored as content 210C-D and associated with sub-subtask 208B (venue contact) in plan 200A. In addition to determining that content 210B completes sub-subtask 208A (booking date/time), it may be determined that content 210C-D completes sub-subtask 208B (venue contact) and together the two sub-subtasks complete subtask 206B (book venue) (see FIG. 2B). Link 214 may be added to subtask 206B (book venue) to provide a back reference to the confirmation email from which content 210B-D were extracted for completing subtask 206B. Further, reasoning chains that led to various determinations for completing subtask 206B (book venue) may be linked to subtask 206B (see FIG. 2C), e.g., reasoning chains for determining the email confirmation was related to booking the venue and/or determining completion statuses for sub-subtask 208A (booking date/time) and sub-subtask 208B (venue contact).

Further with respect to the fourth level, instruction 212B relates to subtask 206C (research venues) and refers to formatting research results for presentation to the user. In some aspects, the system may determine a suitable format for presenting the research, e.g., in a chart; in other aspects, the user may specify a format. Instruction 212B is added to plan 200A with reference to subtask 206C (research venues) and, when plan 200A is surfaced, an LLM, application or interface may ingest instruction 212B to retrieve and present the research results according to the specified formatting.

In further aspects, the system may determine that a plugin or application may aid the user in completing a task, subtask, sub-subtask, etc. For example, a flight reservation app may be useful for a task associated with booking a flight. Subtask 206D is associated with designing a cake for a birthday party. In this case, the system may determine that a designer plugin may be useful to the user. Accordingly, link 218A to a designer plugin may be added to subtask 206D (design cake). When plan 200A is surfaced, link 218A may cause the designer plugin to be surfaced as a selectable icon, for instance. In further aspects, upon utilizing the designer plugin, the user may select or generate one or more images of the desired birthday cake and the images may be added as content 210E.

Sub-subtask 208C (email bakery) is provided in the fourth level with respect to subtask 206E (order cake). In this case, the system may determine that access to an email app may aid the user in sending the email. Link 218B to an email plugin may be associated with sub-subtask 208C (email bakery) and, when plan 200A is surfaced, link 218B may cause an email plugin to be surfaced as a selectable icon, for instance. Instruction 212C further modifies the link 218B, specifying that the design image(s) of the cake (e.g., content 210E) be inserted in the email. In this case, when plan 200A is surfaced, the application or interface may automatically insert an image of the cake design (e.g., content 210E) obtained from subtask 206D (design cake) into the email to the selected bakery. In some examples, although not shown in FIG. 2A, instruction 212C may be further linked to content 210E within plan 200A.

As should be appreciated, the above example of plan 200A is provided for the purposes of explanation and illustration and should not be considered limiting in any way. Plan 200A is illustrated in a hierarchical data structure, but any data structure for storing and tracking progress of a goal, including applicable tasks, subtasks, sub-subtasks, etc., may be utilized without departing from the present disclosure. Also, it will be appreciated that the system may further be implemented to actively complete different tasks, such as through launching plugins, opening websites, offering to launch applications, or launching application without user interaction. Such activities are used to help users complete their tasks, as discussed in more detail below.

FIG. 2B illustrates an overview of an example plan 200B according to aspects described herein. Plan 200B is an example node data structure representing the goal 202 for “a birthday party.” Plan 200B includes a central node, representing the goal 202. As illustrated, each task 204 is represented as a node related to the central node for goal 202, each subtask 206 is represented as a sub-node related to a node for a task 204, and each sub-subtask 208 is represented as a sub-sub-node related to a sub-node for a subtask 206. The reference numerals for each task 204, subtask 206, sub-subtask 208, content 210, instruction 212, reference 214, completion indicator 216, and link 218 correspond to the same reference numerals described with respect to FIG. 2A and will not be discussed further. However, plan 200B illustrates additional non-hierarchical relationships between the nodes.

As noted above, task 204A (schedule party) may be dependent upon subtask 206B (book venue). In examples, in response to determining that the venue has been booked based on a confirmation email, the booking date/time may be extracted as content 210B and associated with sub-subtask 208A (booking date/time). It may further be determined that content 210B is associated with subtask 206A (schedule date/time) and content 210B may be linked to both sub-subtask 208A and subtask 206A in plan 200B, eliminating the need for duplicate content 210A (shown in FIG. 2A). It may be further determined that content 210B completes sub-subtask 208A (booking date/time) and subtask 206A (schedule date/time) and completion indicator 216B may linked to both sub-subtask 208A and subtask 206A, eliminating the need for completion indicator 216A (shown in FIG. 2A). In response to determining subtask 206A (schedule date/time) is completed, it may be further determined that schedule task 204A is completed and completion indicator 216B may also be linked to schedule task 204A in plan 200B.

As further illustrated by FIG. 2B, reference 214 provides a link to content (e.g., a confirmation email) that gave rise to various system determinations for goal 202. Referring to the example above, the confirmation email from the venue was evaluated to determine it was related to subtask 206B (book venue). Additionally, content was extracted from the confirmation email, including, at least, the booking date/time (stored as content 210B) and the contact name/phone (stored as content 210C-D). Thus, in this example, reference 214 points to subtask 206B, content 210B, content 210C, and content 210D, thereby providing a back reference to the content supporting each of these nodes.

Yet further illustrated by FIG. 2B, instruction 212C (insert image) for sub-subtask 208C (email bakery) is shown as linked to both content 210E (cake images) and link 218B (email plugin), thereby enabling the design images of the desired cake to be automatically added to the bakery email when plan 200B is surfaced.

In some cases, as illustrated by FIG. 2B, a node data structure may better model additional node dependencies and/or relationships than hierarchical data structure of FIG. 2A. As should be appreciated, the example of plan 200B is provided for the purposes of explanation and illustration and should not be considered limiting in any way. Plan 200B is illustrated as a node data structure, but any data structure for storing and tracking progress of a goal, including applicable tasks, subtasks, sub-subtasks, etc., may be utilized without departing from the present disclosure.

FIG. 2C illustrates an overview of a subplan 200C of plan 200B (FIG. 2B), according to aspects described herein. The subplan 200C of plan 200B is an example node data structure representing subtask 206B (book venue) and related sub-subtask 208A (booking date/time) and sub-subtask 208B (venue contact).

As described above, in monitoring user interactions, the system may record an email. Upon evaluating the email, the system may extract a subject line, stating “You are confirmed at Mountain Glen (conf. no. A2XX3).” Based on context regarding subtask 206B (book venue) for goal 202 (planning a birthday party), the system may determine that “Mountain Glen” is one of the venues on a list of venues being considered for the birthday party. Accordingly, the system may determine that the email is related to subtask 206B (book venue). Additionally, the reasoning chain 220A giving rise to this determination may be linked to subtask 206B.

The system may evaluate the content of the email and extract conf. no. A2XX3. Based on the confirmation number, the system may determine that user is not merely corresponding with the venue, but that Mountain Glen has been booked for the birthday party. Further inspection of the email may include, among other things, the date/time of booking (e.g., Jan. 6, 2024, at 10:00 AM), a contact name/phone number (e.g., Jenna, 555-555-5555), an address of the venue, and the like. Based on the date/time (e.g., Jan. 6, 2024, 10:00 AM) extracted from the email, the system may determine that this content is related to sub-subtask 208A (booking date/time) and may associate the booking date/time as content 210B with sub-subtask 208A (booking date/time). The system may further associate the reasoning chain 220B giving rise to this determination to sub-subtask 208A. Additionally, based on the contact name/phone number (e.g., Jenna, 555-555-5555) extracted from the email, the system may determine that this content is related to sub-subtask 208B (venue contact) and may associate the contact name as content 210C and the contact phone number as content 210D with sub-subtask 208B (venue contact). The system may further associate the reasoning chain 220C giving rise to this determination to sub-subtask 208B. Additionally, the system may link email 222 supporting the content extractions and reasoning chains 220A-C as reference 214, which points to content 210B-D and is indirectly linked to subtask 206B and sub-subtasks 208A-B. In other examples, email 222 may be linked directly to content 210B-D, subtask 206B, and sub-subtasks 208A-B (not shown).

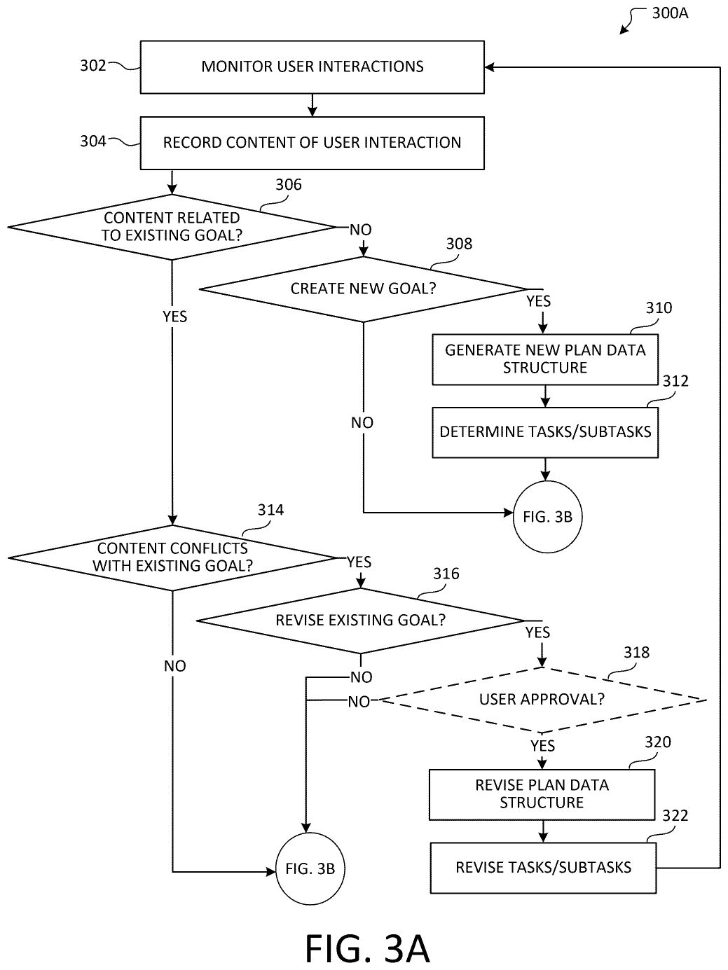

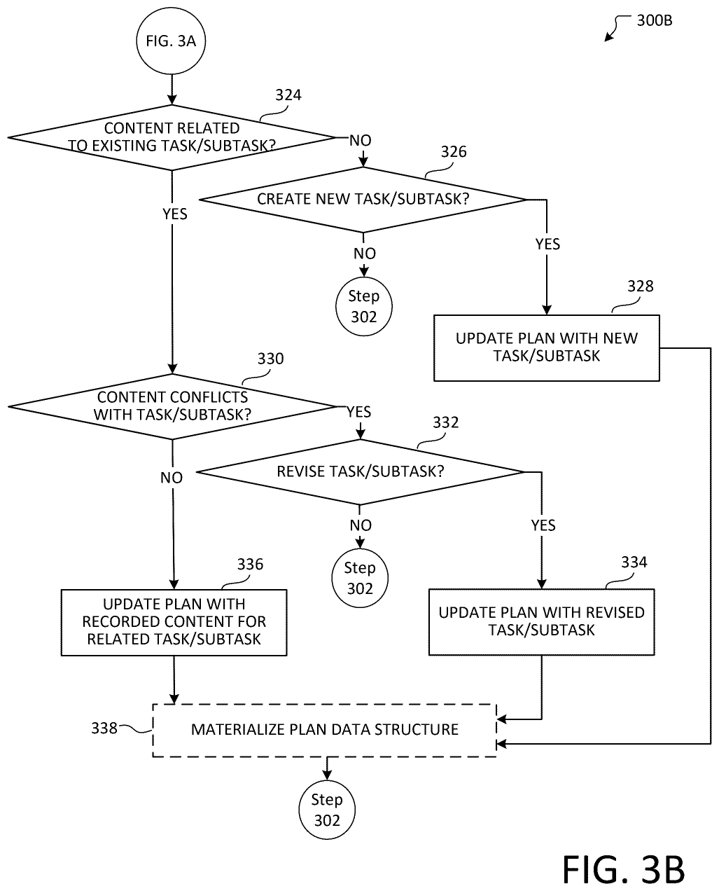

FIG. 3A illustrates an overview of an example method 300A of generating and tracking a goal according to aspects described herein. As illustrated, method 300A begins at monitor operation 302, where user interactions with a computing device (e.g., computing device 104, mobile device 108, camera 110, and watch 112 of FIG. 1) are monitored. Such user interactions include, without limitation, browsing websites, engaging with social platforms, collaborating electronically with friends and colleagues, transacting with apps and/or plugins, creating and editing documents, querying electronic assistants, accessing files, and the like.

At record operation 304, content may be recorded based on a user interaction with a computing device or through monitoring of other related electronic devices. As noted above, users digitally interact with a vast array of entities or sources, including interactions with applications, files, plugins, websites, databases, artificial intelligence (AI) agents, search engines, browsers, software services, social platforms, conferencing platforms, collaboration platforms, and the like. Content recorded based on these interactions may include different content types and formats (e.g., audio, video, image, streaming, graphic, text, HTML, XML, and the like). Moreover, recorded content may include any combination of various content types and formats, e.g., content recorded from a webpage may include images, streaming video, and text, etc. With reference to FIG. 1, recorded content may include, for example, image(s) 116, document(s) 118, email(s) 102A, email attachment(s) 102B, calendar 124, internet content 122, communication content 126A-B, social content 128, pictures 130A-B, and data 132. As should be appreciated, the various examples of content and content types are provided for explanatory purposes only and should not be considered limiting in any way.

At goal determination operation 306, it may be determined whether recorded content is related to an existing goal. For example, the content may be evaluated for correspondence or similarity to existing tasks, subtasks, content, etc., within existing plan data structures associated with existing goals of the user. In aspects, the system may attempt to determine which goal (or task, subtask, etc.) is the focus of the user's intent based on the recorded content, e.g., the goal-in-focus. Any method for determining similarity between the recorded content and an existing goal, either now known or developed in the future, may be utilized in determination operation 306. For example, a cosine similarity may be performed to determine whether a vector (or embedding) representing the recorded content is within a predetermined range of similarity or closeness to vectors representing various aspects of existing plan data structures (e.g., tasks, subtasks, content, instructions, references, etc.) representing existing goals. If the system is able to determine with a degree of confidence that the recorded content is related to an existing goal, the method may progress to conflict determination operation 314. By determining the user's focus, the system is able to determine which goal, task, subtask, etc., to update. Moreover, based on updating a goal, for example, the system may revise tasks, subtasks, etc., beyond the goal-in-focus. This enables the system to be scalable and performant.

In aspects, a determination that content is unrelated to a goal may be based on various factors, e.g., the amount of content is insufficient to detect an intention of a user intention (e.g., short text thread without context), the content relates to an isolated event or topic (e.g., meeting place for lunch today, query for random fact, etc.), the content has no correspondence or similarity to other content (e.g., a query for a location not previously searched or visited), user interaction is unrelated to a task (e.g., watching a cat video, scrolling a social media or news feed, etc.), to name a few. If the system is unable to determine with a degree of confidence that the recorded content is related to an existing goal, the method may progress to create determination operation 308.

At create determination operation 308, the recorded content may be evaluated to determine whether the user intends to create a new goal. For example, the recorded content may be associated with browsing surfboards on a sporting goods website, placing a bid for a surfboard on an online auction site, and querying a search engine for surfboarding courses. Evaluation of the recorded content may identify similarities and these user interactions may be clustered or grouped. In other aspects, the recorded content may be evaluated independently. Based on the evaluation, it may be determined that the goal associated with these interactions is to “learn to surf” In another example, recorded content may be associated with a spreadsheet entitled “Birthday Party Budget,” a website associated with a bakery, and a search engine for querying party supply stores. Based on evaluating the recorded content, it may be determined that the goal associated with these interactions is to “plan a birthday party.” In yet another example, the user may explicitly indicate an intention for a new goal.

When the system determines the user intends to create a new goal, or the user explicitly indicates an intention for a new goal, the method may progress to generate operation 310. In some cases, when the system determines that the user intends to create a new goal, the system may prompt the user for approval (not shown). Alternatively, when the system determines that the recorded content is not related to an existing goal and that the user does not intend to create a new goal, the method may progress to operation 324 of FIG. 3B.

At generate operation 310, a plan (e.g., data structure) for the new goal may be generated to store and track the goal and any associated information. In other examples, multiple plans may be created and related to one another. The plan(s) may be created in any suitable form by any suitable means. For instance, the plan(s) may be in the form of hierarchical structure(s) (e.g., file/folder structure), node structure(s) (e.g., graph database), relational structure(s) (e.g., SQL database), or any combinations thereof. In aspects, the plan(s) are generated in a form that may be processed by a machine-learning model (e.g., LLM) and/or surfaced by an application or interface for presentation to the user. In aspects, the recorded content supporting the system decision to create a new goal may be added as a reference to a folder or node representing the new goal in the plan data structure. Additionally, the reasoning chain supporting the system decision to create a new goal may be linked as a reference to the folder or node representing the new goal in the plan.

At determine operation 312, one or more tasks, subtasks, sub-subtasks, etc., may be determined for the new goal. As should be appreciated, different tasks, subtasks, sub-subtasks, etc., may be determined for different goals. For example, tasks for a goal to “learn to surf” may include:

(1) research surf schools, which may include subtasks of (a) reading customer reviews, (b) reviewing instructor bios, and (c) identifying a course schedule;

(2) research best surfing beaches for beginners, including subtasks of identifying (a) locations, (b) lifeguard services, (c) fees, (d) parking, and (e) hours of operation;

(3) purchase a surfboard, including subtasks of researching (a) suitable surfboards for beginners, (b) pros and cons of used versus new surfboards, and (c) physical and/or online stores for purchasing new or used surfboards; and

(4) book a surfing course, including subtasks of (a) adding the course to the calendar, (b) storing address and contact information, and (c) storing a booking number or other reservation information.

As detailed above, the determined tasks, subtasks, sub-subtasks, etc., may be used to build the plan data structure generated at generate operation 310. In other examples, once the user's intention to create a new goal is determined, tasks, subtasks, sub-subtasks, etc., may first be determined and then the plan data structure may be generated at generate operation 310. Depending on the type of data structure, each task may be added under the goal as a folder or node, each subtask may be added under a task as a subfolder or sub-node, and so forth. The method 300A may then progress to method 300B at task determination operation 324 of FIG. 3B. Also, as detailed above, e.g., in step (4), the system may further take action on behalf of the user. That is, the system may actually book the course on behalf of the user. Such automatic booking can be done via a plugin or by the user's agent interacting with a surfing schools agent or by hitting the surfing schools' API directly, if available.

At conflict determination operation 314, when it is determined that the recorded content is related to an existing goal, it may be determined whether the recorded content conflicts with the existing goal. For example, for the existing goal of “planning a family vacation to Asia,” content related to booking a hotel for all or a portion of the trip dates may be determined not to conflict with the existing goal; whereas content related to a text thread indicating the user instead intends to take “a family vacation to Europe” may be determined to conflict with the existing goal. In another example, described with reference to FIG. 3B, content may be determined not to conflict with an existing goal but may conflict with a task or subtask for the goal. For instance, content may indicate that the user wishes to change a hotel or visit an additional or different city in Asia. While supporting the goal of “planning a family vacation to Asia,” this content may conflict with the current itinerary (e.g., tasks or subtasks on a particular day). If the recorded content is determined not to conflict with the existing goal, the method 300A may progress to method 300B at task determination operation 324 of FIG. 3B. If the recorded content is determined to conflict with the existing goal, the method may progress to revise determination operation 316.

At revise determination operation 316, it may be determined whether the user intends to revise the existing goal. With reference to the above example of recorded content related to a text thread indicating the user intends to take “a family vacation to Europe,” the system may determine that the user intends to revise the existing goal for the family vacation from traveling to Asia to traveling to Europe. Alternatively, the system may determine that, in addition to the existing goal for a family vacation to Asia, the user intends a new goal for a family vacation to Europe. When the system determines the user intends to revise the existing goal, the method may progress to optional approval operation 318, where an interaction with the user may be initiated requesting confirmation of the user intention to revise the existing goal. When the system determines that the user does not intend to revise the existing goal, the method 300A may progress to method 300B at task determination operation 324 of FIG. 3B.

If the user confirms the intention to revise the existing goal, the method may progress to revise operation 320. Alternatively, in another example (not shown), if the user does not confirm the intention to revise the existing goal (e.g., family trip to Asia), the method may return to create determination operation 308, where it may be determined whether the user intends a new goal (e.g., additional family trip to Europe).

At revise plan operation 320, the plan data structure for the existing goal may be revised based on the revised goal. For example, the plan may be revised from a “family vacation to Asia” to a “family vacation to Europe.” Additionally, a link to the content (e.g., the text thread) supporting the determination to revise the goal may be provided as a reference to a folder or node representing the revised goal in the plan. In further aspects, a reasoning chain associated with the system determination for revising the goal may be associated with the folder or node representing the revised goal in the plan.

At revise task operation 322, one or more tasks, subtasks, sub-subtasks, etc., may be determined for the revised goal. With reference to the example above, a task of booking a flight to Asia may be revised to booking a flight to Europe. Similarly, a task of reserving hotels in Asia may be revised to reserving hotels in Europe, and so forth. The revised tasks, subtasks, sub-subtasks, etc., may then update the plan data structure associated with the revised goal. The method may then return to monitor operation 302.

As illustrated by method 300B of FIG. 3B, at task determination operation 324, it may be determined whether recorded content is related to one or more of existing tasks, subtasks, sub-subtasks, content, instructions, links, references, etc., within a plan data structure representing the existing goal. For example, the content may be evaluated for correspondence or similarity using one or more ML models to existing tasks, subtasks, sub-subtasks, content, instruction, etc., of the existing plan data structure. If it is determined that the recorded content is related to one or more existing tasks, subtasks, sub-subtasks, content, instructions, links, references, etc., the method may progress to conflict determination operation 330. If it is determined that the recorded content is not related to one or more existing tasks, subtasks, sub-subtasks, content, instructions, links, references, etc., the method may progress to create determination operation 326.

At create determination operation 326, the recorded content may be evaluated to determine whether the user intends to create a new task, subtask, sub-subtask, content, instruction, etc. For example, the recorded content may be associated with an email between the user and a tour guide in Japan, discussing a salt-water fishing excursion. Alternatively, the recorded content may be an explicit instruction from the user to insert a chart of transportation arrangements into the itinerary. In the first example, it may be determined that the user intends to create a new task of booking a fishing excursion during the family vacation to Asia. In the second example, it may be determined that the user intends to create a new instruction for presenting data related to the transportation arrangements.

When the system determines the user intends to create a new task, subtask, etc., or the user explicitly indicates an intention for a new task, subtask, etc., the method may progress to update operation 328. In some cases, when the system determines that the user intends to create a new task, subtask, etc., the system may prompt the user for approval (not shown). Alternatively, when the system determines that the recorded content is not related to one or more existing tasks, subtasks, etc., and the user does not intend to create a new task, subtask, etc., the method 300B may return to monitor operation 302 of method 300A.

At update operation 328, the plan for the existing goal may be updated based on the new task, subtask, sub-subtask, content, instruction, link, reference, etc. For example, the plan may be revised to add a folder or node for a new task of booking a fishing excursion, which may be determined to include new subtasks of conducting research, such as locations, safety, cancelation guidelines, cost, and/or storing booking information, such as contact information, directions to location, instructions regarding safety, reservation number, cancelation deadline, and the like. Additionally, the content supporting the determination to update the plan with a new task, subtask, etc., may be associated with a folder or node representing the new task, subtask, etc., in the plan. In further aspects, a reasoning chain associated with the system determination for creating a new task, subtask, etc., may be associated with the folder or node representing the new task, subtask, etc., in the plan.

At conflict determination operation 330, when it is determined that the recorded content is related to an existing task, subtask, etc., it may be determined whether the recorded content conflicts with the existing task, subtask, etc. For example, the recorded content may be determined not to conflict with an existing goal but may conflict with a task, subtask, etc., for the goal. For instance, content may indicate that the user wishes to visit an additional or different city in Asia. While supporting the goal of “planning a family vacation to Asia,” this content may conflict with the current itinerary (e.g., task, subtask, etc., on a particular day). If it is determined that the recorded content does not conflict with an existing task, subtask, etc., the method may progress to update operation 336. If it is determined that the recorded content conflicts with an existing task, subtask, etc., the method may progress to revise determination operation 332.

At revise determination operation 332, it may be determined whether the user intends to revise the existing task, subtask, etc. With reference to the above example of recorded content related to visiting an additional or different city in Asia, the system may determine that the user intends to revise the existing task of booking a hotel in one city with booking a hotel in a different city in Asia. If the system determines a user intention to revise the existing task, subtask, etc., the method may progress to update operation 334. In some cases, when the system determines that the user intends to revise a task, subtask, etc., the system may prompt the user for approval (not shown). If the system determines the user does not intend to revise the existing task, subtask, etc., the method 300B may return to monitor operation 302 of method 300A, where user interactions may continue to be monitored.

At update operation 334, the plan for the existing goal may be updated based on the revised task, subtask, sub-subtask, content, instruction, link, reference, etc. For example, the plan may be updated to revise a folder or node associated with the task of booking a hotel in one city with the revised task of booking a hotel in a different city in Asia, which may be determined to include revised subtasks of retrieving location, booking confirmation, cancelation deadline, and the like. Additionally, the content supporting the determination to update the plan with a revised task, subtask, etc., may be associated with a folder or node representing the revised task, subtask, etc., in the plan. In further aspects, a reasoning chain associated with the system determination for revising a task, subtask, etc., may be associated with the folder or node representing the revised task, subtask, etc., in the plan.

At update operation 336, when it is determined that the recorded content is related to and does not conflict with a task, subtask, etc., the data structure for the related task, subtask, etc., may be updated based on the recorded content. For example, data may be extracted (e.g., a reservation number) from the recorded content relating to the task, subtask, etc., and the plan may be updated to add the extracted data or a pointer to the extracted data (e.g., reservation number) to a folder or node representing a task of booking a hotel. Additionally, the recorded content may be linked to the folder or node representing the updated task, subtask, etc., to provide a back reference in the plan. In further aspects, a reasoning chain associated with the system determination for updating a task, subtask, etc., with the recorded content may be associated with the folder or node representing the updated task, subtask, etc., in the plan.

At optional materialize operation 338, the plan may be surfaced or materialized in a user-facing form. For instance, the user may request that the plan be surfaced in an application or interface as any type of document (e.g., word document, spreadsheet, presentation, email, etc.) or any other type of data (e.g., video, images, audio, etc.). The plan may also be materialized by sharing it with other users, applications, LLMs, etc., via any suitable means (e.g., as an attachment or link to email, within a collaborative platform, via text, or otherwise). In further examples, the materialized plan may include a frontend “user-facing” aspect and a backend “model-facing” aspect. The frontend may be formatted and organized for presentation to the user, as described above. In contrast, the backend may include context, prompts, commands, etc., associated with retrieving information, formatting, etc. For example, the backend may instruct an LLM to “research and choose a suitable Asian country for a family vacation,” “find comfortable and child-friendly accommodations in the chosen destination,” or “arrange for transportation to and from the chosen destination.” The backend may further include links or back references to content that led to various determinations (e.g., a link to a chat message in which the user expressed an intention to change the family vacation from Asia to Europe) and/or to the reasoning chains that led to various determinations manifested on the frontend (e.g., the user expressed an intention to vacation in Asia over particular dates, then the user booked a flight to Asia over the particular dates, therefore the task to book the flight is complete). The backend may not be visible to the user; however, if the plan is shared with other users or applications, the backend may also be shared in order to provide context to a recipient application and/or model.

As should be appreciated, operations 302-338 are described for purposes of illustrating the present methods and systems and are not intended to limit the disclosure to a particular sequence of steps, e.g., operations may be performed in a different order and more or fewer operations may be performed without departing from the present disclosure.

FIG. 4 illustrates an example interface 400 for surfacing a plan data structure, e.g., a plan in the form of data structure 200A or data structure 200B. As illustrated, interface 400 includes a document surface 402 associated with a goal 406 for planning a vacation to Japan. In aspects, when the plan data structure for goal 406 is surfaced or materialized in interface 400, instructions included in the plan may specify formatting for presenting tasks, subtasks, content, etc., related to goal 406. In aspects, the formatting may be tailored for a particular goal. For example, the plan for goal 406 (vacation to Japan) is materialized on the document surface 402 as an itinerary 408 based on scheduled dates for the trip.

In aspects, the interface 400 may materialize the plan as a living document, providing functionality to the user for interacting directly with frontend goal 406 and the underlying backend plan data structure. For example, flight information 410 and confirmation no. 412 are presented on the frontend under the first day (e.g., June 4) of itinerary 408. In aspects, these items may be included on the backend in the plan as content associated with a task of booking a flight.

Confirmation number 412 may be associated with a selectable icon for checking into the flight and/or accessing the corresponding boarding pass, where a link to an airline plugin may be associated with the confirmation number content within the plan on the backend, for example. A recommendation 414 for 2-night hotel stay is presented on the same day. In aspects, the recommendation 414 on the frontend may arise from an instruction on the backend to an LLM or other application for retrieving information regarding hotels in Asia.

In further aspects, action icon 416 may initiate a dropdown menu 418, which enables actions to be performed inline from document surface 402. For example, dropdown menu 418 provides inline links 420 via which the user may review recommendation 414, including opening the hotel website, calling the hotel, and/or booking the hotel. Additionally, prompts 422 enable the user to find different hotels, compare reviews, find places to eat, etc. The dropdown menu 418 presented on the frontend may be supported by links corresponding to each website or plugin on the backend in the plan. In this way, the user need not navigate away from the materialized plan for goal 406 to complete tasks, subtasks, etc.; rather, the user is able to take action directly inline from the document surface 402. Goal 406 may be shared with other users, applications, LLMs, etc., via share icon 424, which may also cause the underlying plan data structure to be shared. As illustrated, interface 400 also includes an artificial intelligence (AI) surface 404, enabling the user to interact directly with a bot or other AI agent. In this way, the user may interact with the system regarding goal 406, including providing user input, approvals, requests, etc.

FIG. 5 illustrates an example interface 500 for surfacing a plan data structure, e.g., a plan in the form of data structure 200A or data structure 200B. Similar to interface 400, interface 500 includes a document surface 402 and an AI surface 404 associated with goal 406 for a vacation to Japan. As illustrated by interface 500, the user interacted directly with document surface 402 and inserted user input 502, “Meet Mike for dinner,” into the itinerary for Jun. 4, 2024. As further illustrated, the system responded on the AI surface 404 with prompt 504, “I see that you would like to go to dinner with Mike on June 4, would you like me to make a reservation?” Additionally, the AI surface 404 has provided recommended prompts 506, including “Find restaurants nearby” and “Email Mike.” In aspects, recommended prompts 506 are selectable for initiating the recommended action. In further aspects, the user may interact with the system via input field 508. In this way, interface 500 provides additional means for the user to collaborate with the system as goal 406 takes shape and progress towards completion is tracked.

As described above, document surface 402 may include a frontend “user-facing” aspect (shown) and a backend “ML-facing” aspect (not shown). As illustrated, the frontend of document surface 402 is formatted and organized for presentation to the user. In contrast, the backend of the document surface 402 may include content and instructions readable by applications, interfaces, LLMs, etc., including context, prompts, commands, and/or requests for retrieving information associated with compiling and formatting the document surface 402 for presentation to the user. For example, the backend may instruct an ML model to “research available flights to Tokyo, Japan,” “find comfortable and child-friendly accommodations in Chiyoda City,” or “arrange for transportation to and from Chiyoda City from Tokyo.” The backend may not be visible to the user; however, if the document surface 402 (or the underlying plan data structure) is shared with other users or applications, the backend of the document surface 402 may also be shared in order to provide context to a recipient application, interface, LLM, and the like.

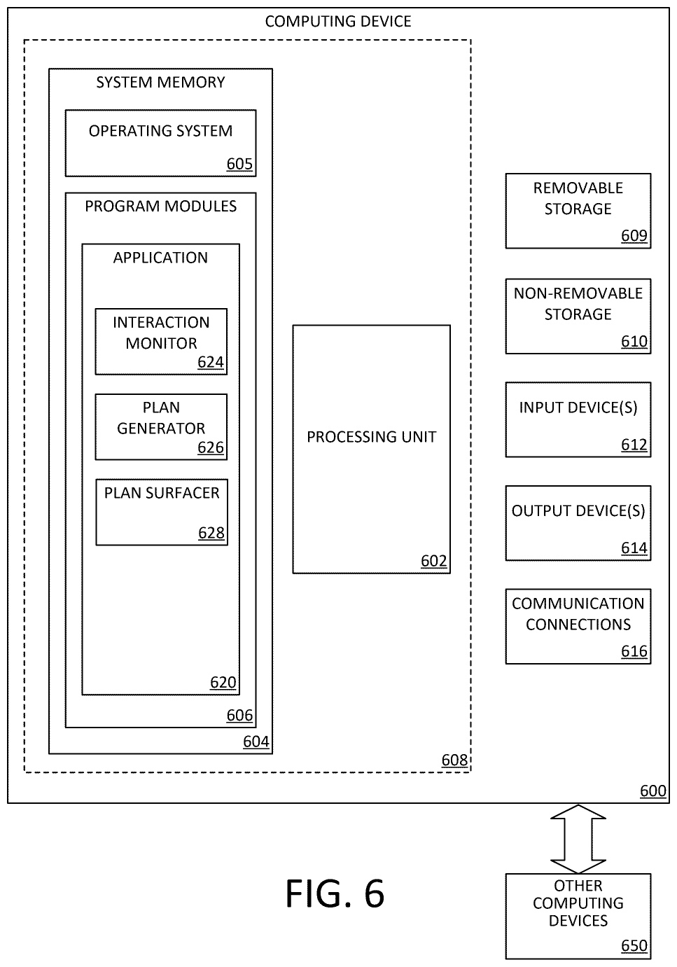

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including computing device 104, server 102, mobile device 108, camera 110, and/or watch 112, discussed above with respect to FIG. 1. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store program modules 606, including application 620, which may further include an interaction monitor 624, plan generator 626, and plan surfacer 628. The operating system 605, for example, may be suitable for controlling the operation of the computing device 600.

Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules 606 and data files may be stored in the system memory 604. While executing on the processing unit 602, the program modules 606 (e.g., application 620) may perform processes including, but not limited to, the aspects, as described herein.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

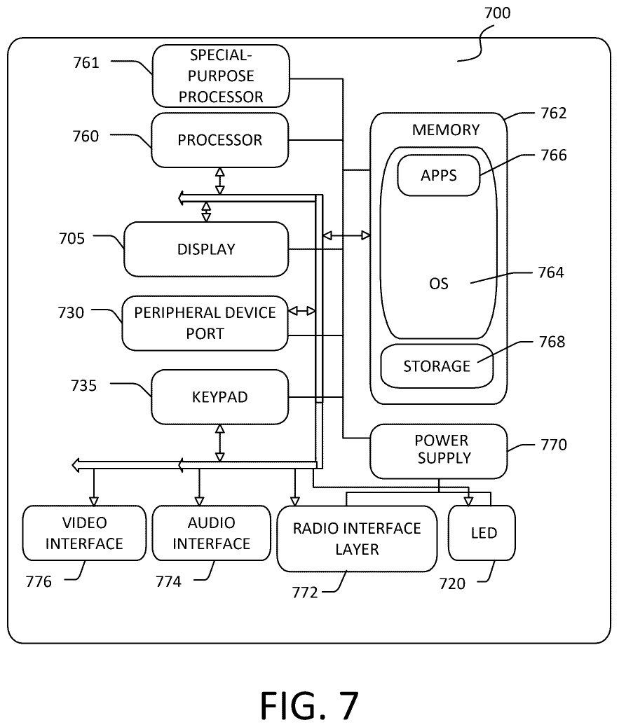

FIG. 7 illustrates a system 700 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 700 is implemented as a “smart phone” capable of running one or more applications (e.g., browser, e-mail, calendaring, contact managers, messaging clients, games, and media clients/players). In some aspects, the system 700 is integrated as a computing device, such as an integrated personal digital assistant (PDA) and wireless phone.

In a basic configuration, such a mobile computing device is a handheld computer having both input elements and output elements. The system 700 typically includes a display 705 and one or more input buttons that allow the user to enter information into the system 700. The display 705 may also function as an input device (e.g., a touch screen display).

If included, an optional side input element allows further user input. For example, the side input element may be a rotary switch, a button, or any other type of manual input element. In alternative aspects, system 700 may incorporate more or less input elements. For example, the display 705 may not be a touch screen in some embodiments. In another example, an optional keypad 735 may also be included, which may be a physical keypad or a “soft” keypad generated on the touch screen display.

In various embodiments, the output elements include the display 705 for showing a graphical user interface (GUI), a visual indicator (e.g., a light emitting diode 720), and/or an audio transducer 725 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 700 also includes a non-volatile storage area 768 within the memory 762. The non-volatile storage area 768 may be used to store persistent information that should not be lost if the system 700 is powered down. The application programs 766 may use and store information in the non-volatile storage area 768, such as e-mail or other messages used by an e-mail application, and the like. A synchronization application (not shown) also resides on the system 700 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the system 700 described herein.

The system 700 has a power supply 770, which may be implemented as one or more batteries. The power supply 770 might further include an external power source, such as an AC adapter or a powered docking cradle that supplements or recharges the batteries.

The system 700 may also include a radio interface layer 772 that performs the function of transmitting and receiving radio frequency communications. The radio interface layer 772 facilitates wireless connectivity between the system 700 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 700 may further include a video interface 776 that enables an operation of an on-board camera 730 to record still images, video stream, and the like.

It will be appreciated that system 700 may have additional features or functionality. For example, system 700 may also include additional data storage devices (removable and/or non-removable) such as, magnetic disks, optical disks, or tape. Such additional storage is illustrated in FIG. 7 by the non-volatile storage area 768.

Data/information generated or captured and stored via the system 700 may be stored locally, as described above, or the data may be stored on any number of storage media that may be accessed by the device via the radio interface layer 772 or via a wired connection between the system 700 and a separate computing device associated with the system 700, for example, a server computer in a distributed computing network, such as the Internet. As should be appreciated, such data/information may be accessed via the radio interface layer 772 or via a distributed computing network. Similarly, such data/information may be readily transferred between computing devices for storage and use according to any of a variety of data/information transfer and storage means, including electronic mail and collaborative data/information sharing systems.

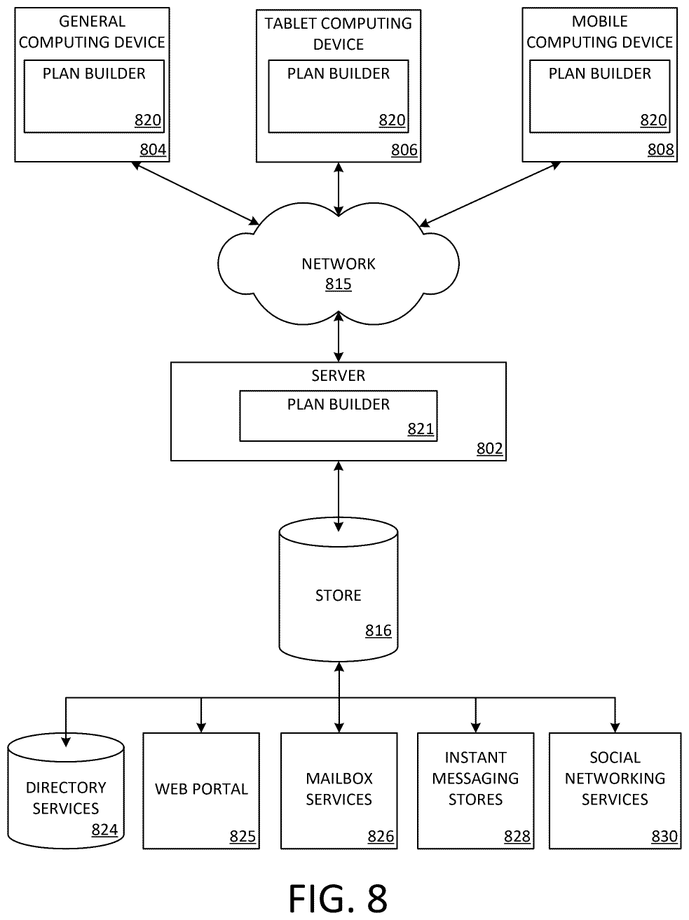

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 824, a web portal 825, a mailbox service 826, an instant messaging store 828, or a social networking site 830.

An application, plan builder 820 (e.g., application 620), may be employed by a client that communicates with server device 802. Additionally, or alternatively, plan builder 821 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these examples of the computing devices may obtain content from the store 816, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

In an aspect, a system is provided, the system including at least one processor and memory storing instructions that, when executed by the at least one processor, cause the system to perform a set of operations. The set of operations includes monitoring a plurality of user interactions with one or more computing devices and recording content associated with at least one user interactions. The user interactions are evaluated to determine whether the content is related to a goal to be accomplished by a user and when it does, updating a data structure representing the goal based on the content. Additionally, the operations may include determining the content is related to existing content in the data structure representing the goal or the content is related to a new goal, wherein a new data structure may be created.

In further aspects of the system described above, where the goal is associated with one or more tasks for completing the goal, and wherein the data structure comprises a node representing each of the one or more tasks, and wherein updating the data structure based on the content further comprises: determining that the content relates to at least one task of the one or more tasks and associating at least a portion of the content with a node representing the at least one task. In further aspects, the system may also associate a reasoning chain to the node, the reasoning chain supporting the determination that the content relates to the at least one task.

In further aspects of the system described above, the operations may further determine that the content completes at least one task and flags the at least one task as complete in the data structure representing the goal. Additionally, the system may further receive a request to surface the data structure; and in response, surface the data structure in one of an application or an interface.

In further aspects of the system, the operations may further comprise determining whether the content updates the goal and/or whether the content conflicts with the goal. When the content conflicts with the goal, determining whether to revise the goal when needed revising the goal by updating the data structure to represent the revised goal. In embodiments, the system may further determine that another other tasks and goals may evaluated for potential updating and further be updated when necessary.

In another aspect, a method for revising a data structure representing a goal to be accomplished by a user is provided. The method including monitoring a plurality of user interactions with one or more computing devices and recording content associated with at least one user interaction. The method also including determining whether the content is related to the goal, wherein the goal is associated with one or more tasks for accomplishing the goal. Based on determining the content is related to at least one task associated with accomplishing the goal, the method further includes determining whether the content conflicts with the at least one task. Based on determining the content conflicts with the at least one task, the method includes automatically revising a node representing the at least one task in a data structure representing the goal, wherein revising the node representing the at least one task includes associating at least a portion of the content with the node.

In further aspects of the method described above, the method further includes determining the content is similar to existing content associated with the at least one task in the data structure to determine whether the content is related with at least one other task or not. The method may further include associating the node representing the at least one task with a reasoning chain supporting the determination that the content conflicts with the at least one task. The method may further include receiving a request to surface the data structure and surfacing the data structure in one of an application or an interface.

In further aspects of the method above, when the content is determined to be related to a new goal, the method further comprises automatically generating a new node representing a new task in the data structure representing the new goal. The method may further include requesting approval from the user before generating the new node representing the new task.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
monitoring a plurality of user interactions with one or more computing devices;
recording content associated with at least one user interaction;
determining whether the content is related to a goal to be accomplished by a user;
based on determining the content is related to the goal, determining whether the content updates the goal; and
based on determining the content updates the goal, updating a data structure representing the goal based on the content.

2. The system of claim 1, wherein determining the content is related to the goal further comprises:
determining the content is related to existing content in the data structure representing the goal.

3. The system of claim 1, wherein the goal is associated with one or more tasks for completing the goal, wherein the data structure comprises a node representing each of the one or more tasks, and wherein updating the data structure based on the content further comprises:
determining that the content relates to at least one task of the one or more tasks; and
associating at least a portion of the content with the node representing the at least one task.

4. The system of claim 3, the set of operations further comprising:
associating, with the node representing the at least one task, a reasoning chain supporting the determination that the content relates to the at least one task.

5. The system of claim 3, the operations further comprising:
determining that the content completes the at least one task; and
flagging the at least one task as complete in the data structure representing the goal.

6. The system of claim 3, wherein the data structure includes computer-readable instructions for presenting the goal to the user, the set of operations further comprising:
receiving a request to surface the data structure; and
surfacing the data structure in one of an application or an interface based on the computer-readable instructions.

7. The system of claim 1, wherein determining the content is related to a goal further comprises:
determining the content is related to an existing goal; or
determining the content is related to a new goal.

8. The system of claim 7, wherein the content is related to a new goal, and wherein the set of operations further comprise:
determining one or more tasks for completing the new goal; and
generating a new data structure representing the new goal, the new data structure including a node representing each task of the determined one or more tasks.

9. The system of claim 1, wherein determining whether the content updates the goal further comprises:
determining whether the content conflicts with the goal;
based on determining that the content conflicts with the goal, determining whether to revise the goal; and
based on determining to revise the goal, updating the data structure to represent the revised goal.

10. The system of claim 1, the set of operations further comprising:
upon updating the goal, determining another goal should be updated; and
updating the other goal.

11. A method for revising a data structure representing a goal to be accomplished by a user, comprising:
monitoring a plurality of user interactions with one or more computing devices;
recording content associated with at least one user interaction;
determining whether the content is related to the goal, wherein the goal is associated with one or more tasks for accomplishing the goal;
based on determining the content is related to at least one task associated with accomplishing the goal, determining whether the content conflicts with the at least one task; and
based on determining the content conflicts with the at least one task, automatically revising a node representing the at least one task in a data structure representing the goal, wherein revising the node representing the at least one task includes associating at least a portion of the content with the node.

12. The method of claim 11, wherein determining the content is related to the at least one task further comprises:
determining the content is similar to existing content associated with the at least one task in the data structure.

13. The method of claim 11, further comprising:
associating, with the node representing the at least one task, a reasoning chain supporting the determination that the content conflicts with the at least one task.

14. The method of claim 11, wherein the data structure includes computer-readable instructions for presenting the goal to the user, the set of operations further comprising:
receiving a request to surface the data structure; and
surfacing the data structure in one of an application or an interface based on the computer-readable instructions.

15. The method of claim 14, wherein the content is related to a new goal, further comprising:
based on determining the content conflicts with the at least one task, automatically generating a new node representing a new task in the data structure representing the goal.

16. The method of claim 15, further comprising:
requesting approval from the user before generating the new node representing the new task.

17. A system comprising:
at least one processor; and
memory storing instructions that, when executed by the at least one processor, cause the system to perform a set of operations, the set of operations comprising:
monitoring a plurality of user interactions with one or more computing devices;
recording content associated with at least one user interaction;
determining whether the content is related to a goal to be accomplished by a user, wherein the goal is associated with one or more tasks for completing the goal;
based on determining the content is related to the goal, determining whether the content conflicts with the one or more tasks associated with the goal;
based on determining the content conflicts with at least one task, determining to revise the at least one task; and
based on the content, automatically revising a node representing the at least one task in a data structure representing the goal.

18. The system of claim 17, wherein revising the data structure based on the content further comprises:
associating at least a portion of the content with the node representing the at least one task;
evaluating other tasks to determine if another task should be updated; and
upon determining another task should be updated, updating the other task.

19. The system of claim 18, the set of operations further comprising:
associating, with the node representing the at least one task, a reasoning chain supporting the determination that the content conflicts with the at least one task.

20. The system of claim 17, wherein the data structure includes computer-readable instructions for presenting the goal to the user, the set of operations further comprising:
receiving a request to surface the data structure; and
surfacing the data structure in one of an application or an interface based on the computer-readable instructions.
